(19) United States
(12) Patent Application Publication
(10) Pub. No.: US 2008/0078921 A1
(43) Pub. Date: Apr. 3, 2008

(54) MULTIPLE LIGHT SENSORS AND ALGORITHMS FOR LUMINANCE CONTROL OF MOBILE DISPLAY DEVICES

(75) Inventors: SEN YANG, PALATINE, IL (US); ROBERT AKINS, PALATINE, IL (US); DAVID EMIG, GURNEE, IL (US); JOHN KAEHLER, LAKE BLUFF, IL (US); ZHIMING ZHUANG, KILDEER, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/467,338

(22) Filed: Aug. 25, 2006

(51) Int. Cl. G01J 1/28; H05B 41/36

(52) U.S. Cl. 250/205; 315/307

(57) ABSTRACT

In a method of controlling a lighting unit of a display, a maximum value of ambient light intensity is determined (156). Ambient light intensity is sensed (154) from a first direction relative to the display and from a second direction, different from the first direction, relative to the display. The lighting unit is driven so that light from the lighting unit has a low intensity (172) when the maximum value is less than a first intensity threshold and so that light from the lighting unit has a high intensity, greater than the low intensity, when the maximum value is greater than a second intensity threshold.

### BACKGROUND OF THE INVENTION

1. Field of the Invention

The present invention relates to lighting systems for displays and, more specifically to a lighting system that compensates for ambient brightness.

2. Background of the Invention

The liquid crystal display (LCD) is a technology widely-used in providing a user interface to many digital devices, such as cellular telephones and personal data assistants. An LCD typically includes a layer of liquid crystals sandwiched between two layers of glass, one or two polarizing filters (depending on the type of liquid crystal used) and a thin film electrode array.

An LCD produces no light by itself, but only modifies light passing through the LCD to achieve display results. While some LCD applications (e.g., digital watches) rely on ambient light to interact with the LCD, many LCDs require a backlight to illuminate the display. Frequently, the backlight includes a row of light emitting diodes (LEDs) disposed at the base of the display and a plate, placed behind the display, that diffuses light from the LEDs.

While backlit LCDs provide a bright display when used away from bright ambient light (such as in a dark room), substantial ambient light can overpower the backlighting of an LCD so as to make it hard to view. The power to the LEDs may be increased to compensate for intense ambient light, but then the display may be too bright and waste device battery power when used in a darker environment.

Some LCDs are fitted with an input that allows the user to adjust the backlight intensity manually. However, such manual controls may take up too much space on small devices, such as cellular telephones, and are inconvenient for the user. Some LCDs include an ambient light sensor, which detects an intensity of ambient light, and a control circuit, which adjusts the intensity of the backlight to correspond to the intensity of ambient light. However, such systems fail to take into account the fact that the overall ambient light intensity might be considerably different than the intensity detected in the direction in which the sensor is pointed. Thus, if the sun is behind the user and the light sensor is pointing toward a shaded area, the control circuit will set the backlight intensity to its lowest value, while the ambient light from the sun would make viewing the display quite difficult. Furthermore, the sensor might become blocked by the user's hand, thereby giving an erroneous reading of ambient light intensity.

Therefore, there is a need for a system for controlling light intensity to a display that measures the overall ambient light intensity and that adjusts the backlight intensity to correspond to the overall ambient light intensity.

### SUMMARY OF THE INVENTION

The disadvantages of the prior art are overcome by the present invention which, in one aspect, is a method of controlling a lighting unit of a display, in which a maximum value of ambient light intensity is determined. Ambient light intensity is sensed from a first direction relative to the display and from a second direction, different from the first direction, relative to the display. The lighting unit is driven so that light from the lighting unit has a low intensity when the maximum value is less than a first intensity threshold and so that light from the lighting unit has a high intensity, greater than the low intensity, when the maximum value is greater than a second intensity threshold.

In another aspect, the invention is a method of controlling light intensity from a lighting unit of a display, in which an average intensity of ambient light around the display is determined. The light intensity is changed from a low value to a high value when the light intensity has been set at a low value and the average intensity has a value above a first predetermined threshold and the light intensity is changed from a high value to a low value when the light intensity has been set at a high value and the average intensity has a value below a second predetermined threshold. The first threshold is greater than the second threshold.

In yet another aspect, the invention is an apparatus for controlling intensity of light from a lighting unit of a display. A first light sensor senses light intensity from a first direction relative to the display and generates a first output corresponding thereto. A second light sensor senses light intensity from a second direction, different from the first direction, relative to the display and generates a second output corresponding thereto. A light intensity control circuit, responsive to the first output and the second output, is configured to determine a maximum value of ambient light intensity sensed from the first light sensor and the second light sensor. The light intensity control circuit is also configured to control an intensity of light generated by the lighting unit of the display so that the intensity is set at a low value when the maximum value is below a first intensity threshold and so that the intensity is set at a high value when the maximum value is above a second intensity threshold.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram showing the relationship between sources of light and shadows that affect readability of a display.

FIG. 2 is a perspective view of a two-sensor cellular telephone.

FIG. 3 is a schematic diagram of a multi-light sensor circuit for use in controlling display backlighting.

FIG. 4A is a diagram of a cellular telephone in which the sun is on the same side of the display as the user's eye.

FIG. 4B is a diagram of a cellular telephone in which the sun is on the opposite side of the display as the user's eye.

FIG. 4C is a chart that relates several display usage scenarios to corresponding backlighting intensities.

FIG. 5 is a flow chart that may be used to control backlighting in one embodiment of the invention.

FIG. 6 is a chart that shows display brightness in dynamic relation to ambient brightness.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

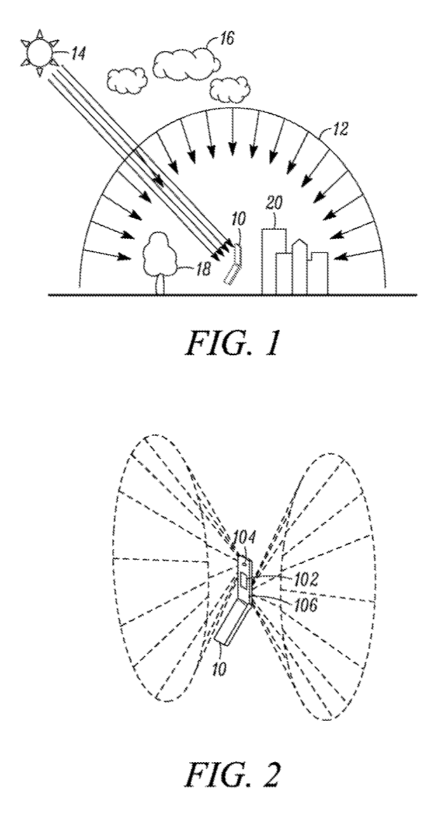

As shown in FIG. 1, the factors that influence perceptibility of a display 10 include: the intensity and direction of light from the sun 14, the diffusive properties of the atmosphere 12, the passing overhead of clouds 16, the shade of trees 18 and both shadows and reflections from buildings 20. As can be seen from FIG. 1, ambient light intensity cannot always be measured accurately by sensing in only one direction relative to the display. Therefore, one embodiment of a device 10 employing a display 102 that is lighted by a lighting unit, as shown in FIG. 2, includes at least a front light sensor 104 and an oppositely directed back light sensor 106. (The cones emanating from light sensor 104 and light sensor 106 each represent the field of view of each sensor.) In some embodiments it would be desirable to employ more than just two light sensors to allow for a more accurate detection of ambient light or if one of the sensors were to be blocked (such as by the user's hand). Also, more than two sensors may provide a more accurate measurement of ambient light in some applications.

The light sensors could include any device capable of providing a meaningful, detectable output in response to light intensity. Examples of light sensors that could be used with the invention include discrete photosensitive semiconductors, pixilated light sensors (which could be within the plane of and mechanical boundaries of the display), thin film transistor light sensors, and charge coupled devices, etc.

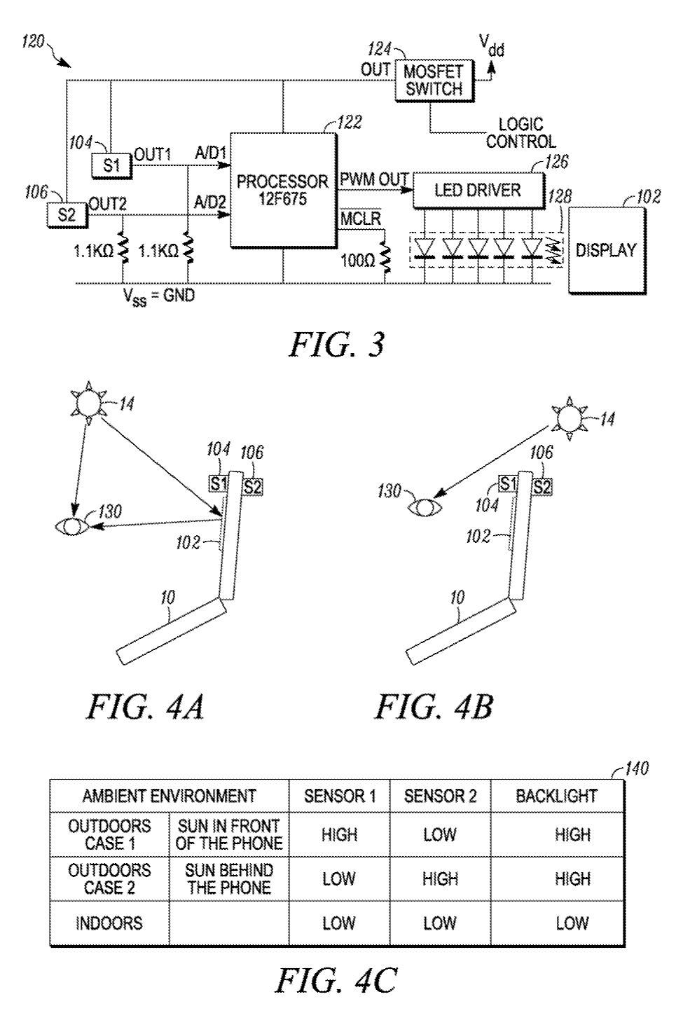

Included in the device 10 is a lighting unit 120 for controlling display brightness, as shown in FIG. 3. The lighting unit 120 could be used as, for example, a back lighting unit, a side lighting unit or a front lighting unit, depending upon the display technology being employed. The lighting unit 120 includes a processor 122 that receives input from the front sensor 104, the back sensor 106 and a logic-controlled switch 124. (As used herein, the term “processor” includes any device capable of generating light intensity control signals of desired values based on light sensor inputs. Examples of devices that qualify under this definition include: microprocessors, microcontrollers, logic circuits constructed of discrete elements and analog control circuits.) The logic-controlled switch 124 can provide input regarding the operating state of the device (e.g., whether the device is actively being used or is in a dormant state) and may also provide stored user preferences to the processor 122.

The processor 122 generates a pulse width modulated (PWM) signal to an LED driver 126 that powers an array of LEDs 128. The PWM signal is a periodic signal in which the percentage of each cycle in which the PWM signal is asserted determines the brightness of the display 102. For example, if the PWM signal is asserted for only 33% of the cycle, then the display 102 will appear to be outputting only about one-third of its maximum brightness and if the PWM signal is asserted for 100% of the cycle, then the display 102 will appear to be outputting its maximum brightness. While PWM is employed in the present embodiment, it should be understood that many other methods of controlling display brightness could be employed within the scope of the invention. For example, the brightness could be modified by controlling the voltage or the current applied to the lighting unit, or any other method of controlling light intensity of a display.

Also, additional light sensors could be employed to increase redundancy. In such a case, rather than using only one first sensor and only one second sensor, a first sensor array and a second sensor array would be used. The processor could average all of the sensors from and array and could reject anomalous signals. This approach would compensate for individual light sensor failure.

In one prototype embodiment, the following components were used: model no. TPS851 light sensors, available from TAEC Sales Office, 2150 E. Lake Cook Road, Suite #310, Buffalo Grove, Ill. 60089; model no.: PIC12F675 microprocessor, available from Microchip Technology Inc., 2355 West Chandler Blvd., Chandler, Ariz., USA 85224-6199; and model no. FDG6324L switch, available from Fairchild Semiconductor. 1721 Moon Lake Blvd., Suite 105, Hoffman Estates Ill. 60194.

In an embodiment employing a PIC12F675 microprocessor, the threshold about which the microprocessor decides the output brightness depends upon the chip's reference voltage. Since this reference voltage depends on the supply voltage, a steady Vdd is important in maintaining a consistent threshold value. Since the MCLR pin for the microprocessor is not used in this embodiment, it is connected to ground through a 100 Ohm resistor. The resistor is necessary because the MCLR pin is sensitive to Voltage spikes below Vss (which in the prototype embodiment equals ground). Without the resistor to maintain the pin voltage slightly above ground, the microprocessor could latch up. This would cause the output PWM to be 100% regardless of the input from the light sensors.

As shown in FIGS. 4A-4C, several different ambient light scenarios are possible. For example, the sun 14 can reflect off of the display 102 into the user's eye 130, as shown in FIG. 4A, which would cause the front sensor 104 to output a high ambient light reading and the back sensor 106 to output a low ambient light reading. In this scenario, as shown in FIG. 4C, it would be desirable for the backlight to output a high intensity to overcome the reflected light from the sun. In another scenario, as shown in FIG. 4B, the sun 14 is behind the display 102 and shining directly into the user's eye 130. In this case, the front sensor 104 will output a low ambient light reading and the back sensor 106 will output a high ambient light reading. Again, it would be desirable for the backlight to output a high intensity to overcome the light from the sun. In an indoor scenario (or one in which the sky was heavily overcast), as shown in FIG. 4C, both sensors output a low reading and it is desirable for the backlight to output a low intensity.

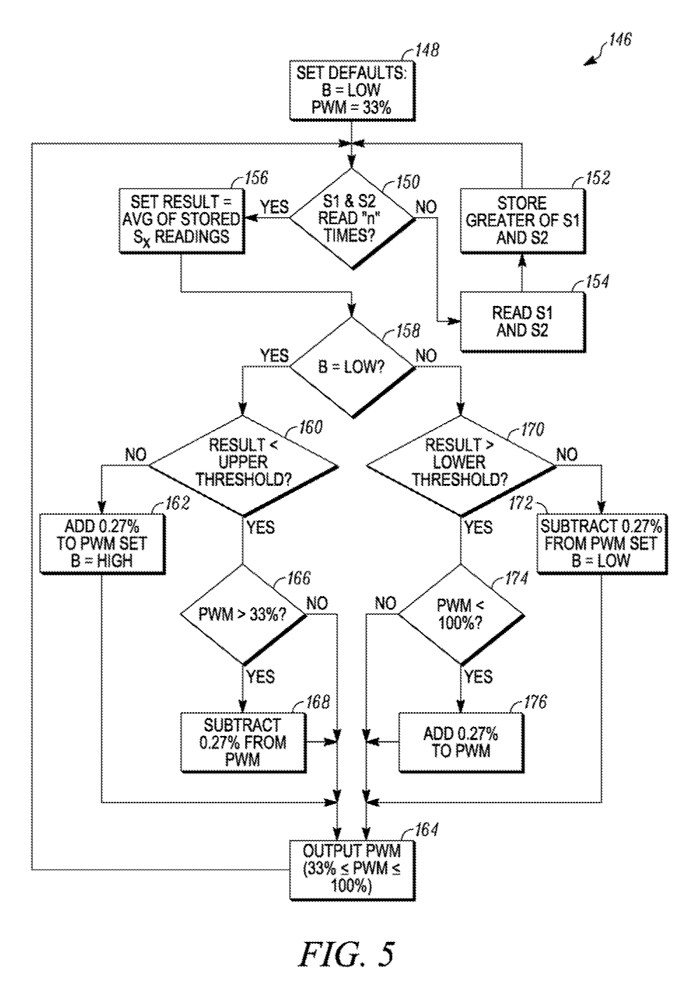

In one method 146 of determining the light intensity, as shown in FIG. 5, the ambient light is periodically sampled. Each of the sampled intensities is summed into a total and the total is divided by the number of samples taken by sensing ambient light from the two different light sensors (e.g. one facing outward from the front of the display and one facing outward from the back of the display). Then the system determines which of the two light sensors indicates the highest intensity of ambient light. The sampled intensity is the highest intensity of ambient light.

Initially, the system sets 148 the brightness state (“B”) to “low” and the pulse width (“PWM”) to 33% (indicating that the asserted pulse width will be 33% of the period of each cycle). A brightness state of “low” indicates either that the output from the display is at its lowest value or that the output is changing in the direction to its lowest value. Similarly, a brightness state of “high” indicates either that the output from the display is at its highest value or that the output is changing in the direction to its highest value. A test 150 determines if both of the sensors (S1 representing the front sensor and S2 representing the back sensor) have been read a predetermined number (“n”) of times. If not, the processor will sample both sensors 154 and store the output from the sensor indicating the greatest ambient light intensity 152. Then the system will return to test 150. If the predetermined number of samples has been read, then the system will calculate the average of the stored sensor readings 156. One way of doing this is to sum each of the stored sensor outputs and divide them by “n.”

The system determines 158 which brightness state it is in. If the current brightness state is “low,” then the system determines 160 if the average result of the stored sensor readings is less than a predetermined “upper” threshold. If the average result is less than the upper threshold, then the system will a predetermined increment (in this embodiment, the increment is 0.27%) to the pulse width output by the processor and will set the brightness state to “high.” 162. If the average result is greater than or equal to the upper threshold, the system will determine 166 if the current pulse width is greater than a predetermined minimum pulse width (in this embodiment, the minimum is 33% of the total cycle time). If the pulse width is at the minimum pulse width, then the system will output 164 its current value for pulse width. If the pulse width is above the minimum, then the system will subtract 168 a predetermined decrement from the pulse width and then output 164 the new current value for pulse width.

Returning to step 158, if the brightness state is not set at “low” (e.g., it is “high”), then the system determines 170 if the average result is greater than a “lower” threshold. If not, then a predetermined decrement is subtracted from the pulse width and the brightness state is set to “low” 172. Otherwise, the system determines if the pulse width is less than a maximum value 174. If not (i.e., the pulse width is currently at its maximum), then the system will output 164 the current value of the pulse width. Otherwise, it will add a predetermined increment to the pulse width 176 and output the pulse width 164. Once the pulse width is output 164, the system repeats the process and returns to step 150. By waiting until the result has gone above a high threshold to begin incrementing output brightness and until the result has gone below a low threshold to begin decrementing brightness, the system adds hysteresis to the brightness control, thereby preventing display brightness jitter as a result of such events as briefly passing under a shadow.

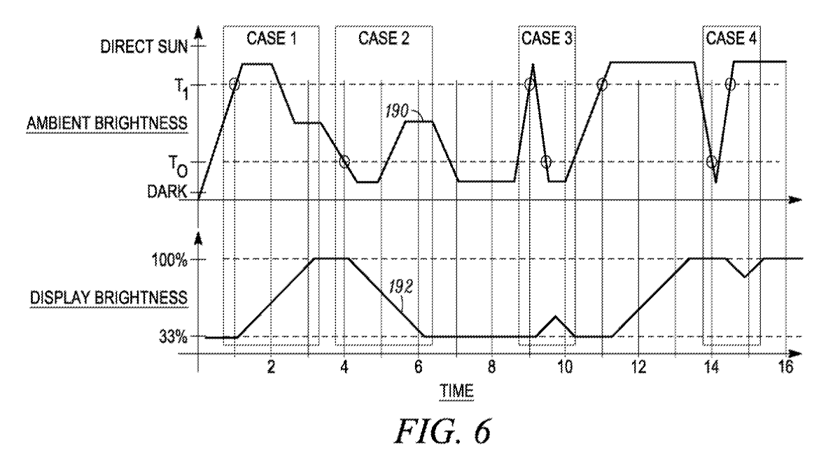

Several brightness transition scenarios are shown in FIG. 6, in which the top curve 190 shows the ambient brightness, as determined above, and the bottom curve 192 shows the brightness output by the display. As the ambient brightness 190 increases past the upper threshold (T1) at time 1, in Case 1, the display brightness 192 begins incrementing and continues to do so until it reaches its maximum value. Even though the ambient brightness 190 has started to decline at time 2, the display brightness 192 continues to increase. It is only when the ambient brightness 190 falls below the lower threshold (T0) at time 4, in Case 2, that the display brightness 192 begins to decrease. In Case 3, the ambient brightness 190 briefly goes above the upper threshold and then below the lower threshold (such as in the case where a bright light is briefly flashed at the device). This causes a brief upward transient in the display brightness 192 between time 9 and time 10. In Case 4, a similar brief downward ambient brightness 190 transient at time 14 (such as in the case where the device briefly passes under a tree) causes the display brightness 192 to move down briefly and then return to its maximum value.

In one embodiment, a visually smooth transition is used to change display intensity from one brightness level to the next. Multiple auxiliary lighting brightness steps may be employed when transitioning from one final auxiliary lighting level to the next in order to produce a visually smooth transition. For example, in one embodiment, going from a high intensity to a low intensity may involve 100 steps. One embodiment of a display lighting system could employ multiple first and second thresholds and correspondingly multiple final (target) auxiliary lighting levels. Also, the invention can be applied to self-emissive displays and any display that provides its own light without or in conjunction with auxiliary lighting, such as organic light emitting diode (OLED) displays.

In one embodiment, it may be desirable to increase the lighting of the display when the display is in a relatively dark environment and decrease the lighting of the display when the display is in a relatively light environment. This embodiment could be useful with displays such as transflective displays (displays that use ambient light for illumination) and key pads (displays used for user input). In such an embodiment, the lighting unit is driven so that light from the lighting unit has a high intensity value when the maximum value is less than a first intensity threshold and so that light from the lighting unit has a low intensity, less than the low intensity, when the maximum value is greater than a second intensity threshold.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method of controlling a lighting unit of a display, comprising the steps of:
a. determining a maximum value of ambient light intensity sensed from a first direction relative to the display and from a second direction, different from the first direction, relative to the display; and
b. driving the lighting unit so that light from the lighting unit has a low intensity when the maximum value is less than a first intensity threshold and so that light from the lighting unit has a high intensity, greater than the low intensity, when the maximum value is greater than a second intensity threshold.

2. The method of claim 1, wherein the second intensity threshold is greater than the first intensity threshold.

3. The method of claim 1, further comprising the steps of:
a. during a predetermined period of time, periodically sensing ambient light intensities from the first direction and from the second direction, thereby sensing a plurality of first direction intensities and a temporally corresponding plurality of second direction intensities;
b. determining, for each of the plurality of first direction intensities and corresponding second direction intensities, a greater intensity of ambient light intensity and storing each greater intensity; and
c. calculating an average of each greater intensity and setting the maximum value equal to the average.

4. The method of claim 1, wherein the lighting unit is driven by a power signal and wherein the driving step comprises modulating a pulse width of a plurality of periodic pulses of the power signal to set the intensity of light from the lighting unit.

5. The method of claim 4, wherein the driving step further comprises:
a. driving the pulse width a first percentage of a period to achieve the low intensity value; and
b. driving the pulse width to a second percentage, greater than the first percentage, of the period to achieve the high intensity value.

6. A method of controlling light intensity from a lighting unit of a display, comprising the steps of:
a. determining an average intensity of ambient light around the display; and
b. changing the light intensity from a low value to a high value when the light intensity has been set at a low value and the average intensity has a value above a first predetermined threshold and changing the light intensity from a high value to a low value when the light intensity has been set at a high value and the average intensity has a value below a second predetermined threshold, the first threshold being greater than the second threshold.

7. The method of claim 6, wherein the determining step comprises the steps of:
a. sensing ambient light from at least two light sensors; and
b. determining which of the at least two light sensors indicates the highest intensity of ambient light.

8. The method of claim 7, further comprising the step of directing each of the two different light sensors in different directions.

9. The method of claim 8, wherein the directing step comprises the steps of:
a. directing a first of the two different light sensors in a direction in front of the display; and
b. directing a second of the two different light sensors in a direction in back of the display.

10. The method of claim 6, wherein the determining step comprises the steps of:
a. periodically sampling ambient light so as to take a predetermined number of samples;
b. summing into a total each sampled intensity of the predetermined number of samples; and
c. dividing the total by the predetermined number.

11. The method of claim 10, wherein the step of periodically sampling ambient light comprises the steps of:
a. sensing ambient light from at least two different light sensors; and
b. determining which of the two light sensors indicates the highest intensity of ambient light; and
c. designating the highest intensity of ambient light as the sampled intensity.

12. The method of claim 11, further comprising the step of directing each of the two different light sensors in different directions.

13. The method of claim 12, wherein the directing step comprises the steps of:
a. directing a first of the two different light sensors in a direction in front of the display; and
b. directing a second of the two different light sensors in a direction in back of the display.

14. A method of controlling a lighting unit of a display, comprising the steps of:
a. determining a maximum value of ambient light intensity sensed from a first direction relative to the display and from a second direction, different from the first direction, relative to the display; and
b. driving the lighting unit so that light from the lighting unit has a high intensity value when the maximum value is less than a first intensity threshold and so that light from the lighting unit has a low intensity, less than the low intensity, when the maximum value is greater than a second intensity threshold.

15. An apparatus for controlling intensity of light from a lighting unit of a display, comprising:
a. a first light sensor that senses light intensity from a first direction relative to the display and that generates a first output corresponding thereto;
b. a second light sensor that senses light intensity from a second direction, different from the first direction, relative to the display and that generates a second output corresponding thereto;
c. a light intensity control circuit, responsive to the first output and the second output, that is configured to determine a maximum value of ambient light intensity sensed from the first light sensor and the second light sensor and that is configured to control an intensity of light generated by the lighting unit of the display so that the intensity is set at a low value when the maximum value is below a first intensity threshold and so that the intensity is set at a high value when the maximum value is above a second intensity threshold.

16. The apparatus of claim 15, wherein the second intensity threshold is greater than the first intensity threshold.

17. The apparatus of claim 15, wherein the light intensity control circuit comprises a processor configured to output a pulse width modulation output that drives the lighting unit of the display so that the intensity has the high value when a high pulse width modulation percentage is output from the processor and so that the intensity has the low value when a low pulse width modulation percentage, less than the high pulse width modulation percentage, is output from the processor.

18. The apparatus of claim 15, further comprising at least a third light sensor, spaced apart from the first light sensor and the second light sensor, that senses light intensity and that generates a third output corresponding thereto, wherein the light intensity control circuit is responsive to the third output and wherein the light intensity control circuit employs the third output in determining the maximum value.

19. The apparatus of claim 15, wherein the first direction is in front of the display and wherein the second direction is in back of the display.
